(19) United States
(12) Patent Application Publication
(10) Pub. No.: US 2009/0244706 A1
(43) Pub. Date: Oct. 1, 2009

(54) Illumination Method for Displaying Different Graphical Layouts

(76) Inventors: Tapani Levola, Tampere (FI); Pauli Laitinen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/992,687

(22) PCT Filed: Sep. 12, 2006
(86) PCT No.: PCT/IB2006/002501

§ 371 Date: Dec. 12, 2008

(30) Foreign Application Priority Data
Oct. 13, 2005 (IB) PCTIB2005/003055

(51) Int. Cl. G02B 27/42

(52) U.S. Cl. 359/569

(57) ABSTRACT

The specification and drawings present a new method, apparatus and software product for illuminating different graphical layouts in a component comprising an optical device, e.g., in a keyboard or in a liquid crystal display of an electronic device. The optical device uses a diffractive planar waveguide comprising diffraction gratings disposed on a lightguiding plate and the property that a short period diffractive grating has no diffraction orders at certain conical angles. Therefore, the out-coupling gratings on the waveguide are designed so that the optical beam coming from a certain direction can be effectively coupled out of the waveguide or be kept confined inside of the waveguide due to a total internal reflection. Then different graphical layouts can be disposed on the waveguide using, e.g., pixels having diffraction gratings with periodic lines at different orientations. Multiple substrate (waveguide) arrangements are described.

### PRIORITY AND CROSS-REFERENCE TO RELATED APPLICATION

This application claims priority from International PCT Application No. PCT/IB2005/003055 filed Oct. 13, 2005.

### TECHNICAL FIELD

The present invention relates generally to electronic devices and, more specifically, to illuminating different graphical layouts, e.g., in keyboards or in liquid crystal displays.

### BACKGROUND ART

Modern electronic devices often have a liquid crystal display and a keyboard to provide and receive information to the user. In order to make the display or the keyboard readable even in darkness, the display or the keyboard can be generally lit by means of light emitting diodes.

### DISCLOSURE OF THE INVENTION

According to a first aspect of the invention, an optical device, comprises: a substrate of optical material comprising a first surface and a second surface; at least two areas on the substrate each comprising one of at least two types of diffractive elements disposed on the first or the second surface of the substrate, wherein periodic lines of a first of the at least two types of diffractive elements have a direction of the periodic lines substantially different from a direction of further periodic lines of a second of the at least two types of diffractive elements according to a predetermined criterion; and optical sources, for providing at least two types of optical beams defined by wave-vectors k₁ and k₂, respectively, wherein both optical beams are substantially confined between the first and the second surfaces due to a total internal reflection; wherein at least part of the optical beam defined by the wave-vector k₁ is diffracted in one of the at least two areas comprising the first of the at least two types of diffractive elements providing an output optical beam out of the first or the second surface, wherein the optical beam defined by the wave-vector k₁ is diffracted or reflected in another of at least two areas comprising the second of the at least two types of diffractive elements without providing the output optical beam out of the first or the second surface, and at least part of the optical beam defined by the wave-vector k₂ is diffracted in the another of at least two areas comprising the second of the at least two types of diffractive elements providing a further output optical beam out of the first or the second surface, wherein the optical beam defined by the wave-vector k₂ is diffracted or reflected in the one of the at least two areas comprising the first of the at least two types of diffractive elements without providing the further output optical beam out of the first or the second surface.

According further to the first aspect of the invention, the direction of the periodic lines may be perpendicular to the direction of the further periodic lines.

According further to the first aspect of the invention, the optical beam defined by the wave-vector k₁ may be in a plane substantially perpendicular to the periodic lines and the optical beam defined by the wave-vector k₂ may be in a plane substantially perpendicular to the further periodic lines.

Still further according to the first aspect of the invention, the optical beams with the wave-vectors k₁ and k₂ may have different angles of incidence on the substrate.

According further to the first aspect of the invention, the optical beams with the wave-vectors k₁ and k₂ may have substantially the same wavelength.

According still further to the first aspect of the invention, the optical beams with the wave-vectors k₁ and k₂ may be provided by light emitting diodes (LEDs).

According yet further still to the first aspect of the invention, each of the at least two types of diffractive elements may be for identifying a graphical layout, such that the at least two types of diffractive elements identify at least two different graphical layouts, respectively. Further, the at least two different graphical layouts may be two different areas of the substrate, the at least two different graphical layouts are not overlapping each other. Further still, the at least two different graphical layouts may be provided in the same area of the substrate and may overlap each other. Yet still further, N different graphical layouts of the at least two different graphical layouts may be provided on the substrate, wherein the N different graphical layouts are identified using 2N optical beams with 2N wave-vectors k₁, k₂, . . . k_{2N}, respectively, provided to the substrate. Still yet further, at least one optical beam may have a wavelength different from other wavelengths of the 2N optical beams and wherein a graphical layout identified by the at least one optical beam may be covered by an optical band-pass filter transparent to the at least one optical beam but opaque to any optical beam out of the N optical beams which has a wavelength different from the wavelength of the at least one optical beam.

Still yet further according to the first aspect of the invention, both of the at least two types of diffractive elements may be disposed on one surface, the first or the second surface of the substrate.

Still further still according to the first aspect of the invention, each of the at least two types of diffractive elements may be disposed on different surfaces, the first and the second surfaces of the substrate.

According further still to the first aspect of the invention, any of the at least two areas may comprise a group of pixels with identical diffractive properties, wherein the pixels have identical or non-identical shapes and sizes.

According yet further still to the first aspect of the invention, the optical device may further comprise: at least one further substrate of optical material comprising a first further surface and a second further surface; at least two further areas on the substrate each comprising one of at least two further types of diffractive elements disposed on the first or the second further surface of the at least one further substrate, wherein periodic lines of a first of the at least two further types of diffractive elements have a direction of the periodic lines substantially different from a direction of further periodic lines of a second of the at least two further types of diffractive elements according to a predetermined criterion; and further optical sources, for providing at least two further types of optical beams defined by a wave-vectors k₃ and k₄, respectively, and both optical beams are substantially confined between the first and the second further surfaces due to a total internal reflection; wherein at least part of the optical beam defined by the wave-vector k₃ is diffracted in one of the at least two further areas comprising the first of the at least two further types of diffractive elements providing another output optical beam out of the first or the second further surface, wherein the optical beam defined by the wave-vector k₃ is diffracted or reflected in another of at least two further areas comprising the second of the at least two further types of diffractive elements without providing the another output optical beam out of the first or the second surface, and at least part of the optical beam defined by the wave-vector k₄ is diffracted in the another of at least two further areas comprising the second of the at least two further types of diffractive elements providing another further output optical beam out of the first or the second further surface, wherein the optical beam defined by the wave-vector k₄ is diffracted or reflected in the one of the at least two further areas comprising the first of the at least two further types of diffractive elements without providing the another further output optical beam out of the first or the second further surface.

According still yet further to the first aspect of the invention, each of at least two types of diffractive elements may be for identifying a graphical layout, such that the at least two types of diffractive elements identify at least two different graphical layouts, and wherein each of the at least two further types of diffractive elements may be for identifying a graphical layout, such that the at least two further types of diffractive elements identify at least two further different graphical layouts, respectively. Further, the all wave-vectors k₁, k₂, k₃ and k₄ may have at lease one of: a) substantially the same wavelength, b) k₁ and k₃ having substantially the same direction, and c) k₂ and k₄ having substantially the same direction. Further still, the wave-vectors k₁ and k₂ may have substantially one wavelength, and the wave-vectors k₃ and k₄ may have substantially further wavelength, wherein the further wavelength may be different from the one wavelength. Yet still further, the substrate and the at least one further substrate may be placed one below another in parallel planes such that at least one graphical layout out of the two different graphical layouts may be adapted to be displayed in a region seen by a user of the optical device and at least one further graphical layout out of the at least two further different graphical layouts is adapted to be displayed in the region seen by the user as well.

According still yet further still to the first aspect of the invention, the at least two further different graphical layouts may be two different areas of the further substrate, the at least two further different graphical layouts are not overlapping each other.

According further still to the first aspect of the invention, the at least two further different graphical layouts may be provided in the same area of the further substrate and overlap each other.

According to a second aspect of the invention, a method for illuminating a component of an electronic device, comprises: receiving an optical beam, defined by a wave-vector k₁ or by a wave-vector k₂, by a substrate of optical material contained in the component and comprising a first surface and a second surface, wherein at least two areas on the substrate each comprising one of at least two types of diffractive elements disposed on the first or the second surface of the substrate, wherein periodic lines of a first of the at least two types of diffractive elements have a direction of the periodic lines substantially different from a direction of further periodic lines of a second of the at least two types of diffractive elements; propagating the optical beam substantially between the first and the second surfaces due to a total internal reflection; diffracting, if the optical beam is defined by the wave-vector k₁, at least part of the optical beam defined by the wave-vector k₁ in one of the at least two areas comprising the first of the at least two types of diffractive elements providing an output optical beam out of the first or the second surface, wherein the optical beam defined by the wave-vector k₁ is diffracted or reflected in another of the at least two areas comprising the second of the at least two types of diffractive elements without providing the output optical beam out of the first or the second surface or diffracting, if the optical beam is defined by the wave-vectors k₂, at least part of the optical beam defined by the wave-vector k₂ in the another of the at least two areas comprising the second of the at least two types of diffractive elements providing a further output optical beam out of the first or the second surface, wherein the optical beam defined by the wave-vector k₂ is diffracted or reflected in the one of the at least two areas comprising the first of the at least two types of diffractive elements without providing the further output optical beam out of the first or the second surface.

According further to the second aspect of the invention, the direction of the periodic lines may be perpendicular to the direction of the further periodic lines.

Further according to the second aspect of the invention, the optical beam defined by the wave-vector k₁ may be in a plane substantially perpendicular to the periodic lines and the optical beam defined by the wave-vector k₂ is in a plane substantially perpendicular to the further periodic lines.

Still further according to the second aspect of the invention, the optical beams with the wave-vectors k₁ and k₂ may have different angles of incidence on the substrate.

According further to the second aspect of the invention, the optical beams with the wave-vectors k₁ and k₂ may have substantially the same wavelength.

According still further to the second aspect of the invention, the optical beams with the wave-vectors k₁ and k₂ may be provided by light emitting diodes (LEDs).

According further still to the second aspect of the invention, each of the at least two types of diffractive elements may be for identifying a graphical layout, such that the at least two types of diffractive elements identify at least two different graphical layouts, respectively. Further, the at least two different graphical layouts may be two different areas of the substrate, the at least two different graphical layouts are not overlapping each other. Further still, the at least two different graphical layouts may be provided in the same area of the substrate and overlap each other. Yet further still, N different graphical layouts of the at least two different graphical layouts may be provided on the substrate, wherein the N different graphical layouts are identified using 2N optical beams with 2N wave-vectors k₁, k₂, . . . k_{2N}, respectively, provided to the substrate. Still further still, at least one optical beam may have a wavelength different from other wavelengths of the 2N optical beams and wherein a graphical layout identified by the at least one optical beam is covered by an optical band-pass filter transparent to the at least one optical beam but opaque to any optical beam out of the N optical beams which has a wavelength different from the wavelength of the at least one optical beam.

According yet further still to the second aspect of the invention, both of the at least two types of diffractive elements may be disposed on one surface, the first or the second surface of the substrate.

Yet still further according to the second aspect of the invention, each of the at least two types of diffractive elements may be disposed on different surfaces, the first and the second surfaces of the substrate.

Still yet further according to the second aspect of the invention, the component may be a key of a keyboard.

Still further still according to the second aspect of the invention, the component may be a liquid crystal display.

Yet still further still according to the second aspect of the invention, any of the at least two areas comprise a group of pixels with identical diffractive properties, wherein the pixels may have identical or non-identical shapes and sizes.

Still yet further still according to the second aspect of the invention, the invention may further comprise: receiving an optical beam, defined by a wave-vector k₃ or by a wave-vector k₄, by a further substrate of optical material contained in the component and comprising a first further surface and a second further surface, wherein at least two further areas on the further substrate each comprising one of at least two further types of diffractive elements disposed on the first or the second further surface of the further substrate, wherein periodic lines of a first of the at least two further types of diffractive elements have a direction of the periodic lines substantially different from a direction of further periodic lines of a second of the at least two further types of diffractive elements; propagating the optical beam substantially between the first and the second further surfaces due to a total internal reflection; diffracting, if the optical beam is defined by the wave-vector k₃, at least part of the optical beam defined by the wave-vector k₃ in one of the at least two further areas comprising the first of the at least two further types of diffractive elements providing another output optical beam out of the first or the second (further surface, wherein the optical beam defined by the wave-vector k₃ is diffracted or reflected in another of the at least two further areas comprising the second of the at least two further types of diffractive elements without providing the another output optical beam out of the first or the second further surface or diffracting, if the optical beam is defined by the wave-vectors k₄, at least part of the optical beam defined by the wave-vector k₄ in the another of the at least two further areas comprising the second of the at least two further types of diffractive elements providing another further output optical beam out of the first or the second further surface, wherein the optical beam defined by the wave-vector k₄ is diffracted or reflected in the one of the at least two further areas comprising the first of the at least two further types of diffractive elements without providing the another further output optical beam out of the first or the second further surface.

According further still to the second aspect of the invention, each of at least two types of diffractive elements may be for identifying a graphical layout, such that the at least two types of diffractive elements identify at least two different graphical layouts, and wherein each of the at least two further types of diffractive elements may be for identifying a graphical layout, such that the at least two further types of diffractive elements identify at least two further different graphical layouts, respectively. Further, all wave-vectors k₁, k₂, k₃ and k₄ may have at lease one of: a) substantially the same wavelength, b) k₁ and k₃ having substantially the same direction, and c) k₂ and k₄ having substantially the same direction. Further still, the wave-vectors k₁ and k₂ may have substantially one wavelength, and the wave-vectors k₃ and k₄ have substantially further wavelength, wherein the further wavelength is different from the one wavelength. Yet further still, the substrate and the at least one further substrate may be placed one below another in parallel planes such that at least one graphical layout out of the two different graphical layouts is adapted to be displayed in a region seen by a user of the optical device and at least one further graphical layout out of the at least two further different graphical layouts is adapted to be displayed in the region seen by the user as well.

Further according to the second aspect of the invention, at least two further different graphical layouts may be different areas of the further substrate, the at least two further different graphical layouts are not overlapping each other.

Still further according to the second aspect of the invention, at least two further different graphical layouts may be provided in the same area of the further substrate and overlap each other.

According to a third aspect of the invention, a computer program product comprising: a computer readable storage structure embodying computer program code thereon for execution by a computer processor with the computer program code wherein the computer program code comprises instructions for performing the second aspect of the invention, indicated as being performed by any component of the electronic device.

According to a fourth aspect of the invention, an electronic device, comprises:
(a) an optical device, comprising
   a substrate of optical material comprising a first surface and a second surface;
   at least two areas on the substrate each comprising one of at least two types of diffractive elements disposed on the first or the second surface of the substrate, wherein periodic lines of a first of the at least two types of diffractive elements have a direction of the periodic lines substantially different from a direction of further periodic lines of a second of the at least two types of diffractive elements;
   optical sources, for providing at least two types of optical beams defined by wave-vectors k₁ and k₂, respectively, wherein both optical beams are substantially confined between the first and the second surfaces due to a total internal reflection; wherein
   at least part of the optical beam defined by the wave-vector k₁ is diffracted in one of the at least two areas comprising the first of the at least two types of diffractive elements providing an output optical beam out of the first or the second surface, wherein the optical beam defined by the wave-vector k₁ is diffracted or reflected in another of the at least two areas comprising the second of the at least two types of diffractive elements without providing the output optical beam out of the first or the second surface, and
   at least part of the optical beam defined by the wave-vector k₂ is diffracted in the another of the at least two areas comprising the second of the at least two types of diffractive elements providing a further output optical beam out of the first or the second surface, wherein the optical beam defined by the wave-vector k₂ is diffracted or reflected in the one of the at least two areas comprising the first of the at least two types of diffractive elements without providing the further output optical beam out of the first or the second surface;
(b) a component comprising the substrate;
(c) a mode selector, responsive to an instruction signal, for providing a mode selection signal in response to the instruction signal, wherein the mode selection signal indicates whether the optical beam with the wave-vectors k₁ or k₂ is used; and
(d) a light source driver, responsive to the mode selection signal, for providing a drive signal to a light source in the component for providing the optical beam with the wave-vectors k₁ or k₂.

According further to the fourth aspect of the invention, the component may be a key of a keyboard.

Further according to the fourth aspect of the invention, the component may be a liquid crystal display.

Still further according to the fourth aspect of the invention, the electronic device may be for wireless communications.

According further to the fourth aspect of the invention, any of the at least two areas may comprise a group of pixels with identical diffractive properties, wherein the pixels have identical or non-identical shapes and sizes.

According still further to the fourth aspect of the invention, each of the at least two types of diffractive elements may be for identifying a graphical layout, such that the at least two types of diffractive elements identify at least two different graphical layouts, respectively. Further, the at least two different graphical layouts may be two different areas of the substrate, the at least two different graphical layouts are not overlapping each other. Further still, the at least two different graphical layouts may be provided in the same area of the substrate and overlap each other. Still further, N different graphical layouts of the at least two different graphical layouts may be provided on the substrate, wherein the N different graphical layouts are identified using 2N optical beams with 2N wave-vectors k₁, k₂, . . . k_{2N}, respectively, provided to the substrate.

According further still to the fourth aspect of the invention, at least one optical beam may have a wavelength different from other wavelengths of the 2N optical beams and wherein a graphical layout identified by the at least one optical beam may be covered by an optical band-pass filter transparent to the at least one optical beam but opaque to any optical beam out of the N optical beams which may have a wavelength different from the wavelength of the at least one optical beam.

Yet still further according to the fourth aspect of the invention, the optical device may further comprise: at least one further substrate of optical material comprising a first further surface and a second further surface; at least two further areas on the substrate each comprising one of at least two further types of diffractive elements disposed on the first or the second further surface of the at least one further substrate, wherein periodic lines of a first of the at least two further types of diffractive elements have a direction of the periodic lines substantially different from a direction of further periodic lines of a second of the at least two further types of diffractive elements according to a predetermined criterion; and further optical sources, for providing at least two further types of optical beams defined by a wave-vectors k₃ and k₄, respectively, and both optical beams are substantially confined between the first and the second further surfaces due to a total internal reflection; wherein at least part of the optical beam defined by the wave-vector k₃ is diffracted in one of the at least two further areas comprising the first of the at least two further types of diffractive elements providing another output optical beam out of the first or the second further surface, wherein the optical beam defined by the wave-vector k₃ is diffracted or reflected in another of at least two further areas comprising the second of the at least two further types of diffractive elements without providing the another output optical beam out of the first or the second surface, and at least part of the optical beam defined by the wave-vector k₄ is diffracted in the another of at least two further areas comprising the second of the at least two further types of diffractive elements providing another further output optical beam out of the first or the second further surface, wherein the optical beam defined by the wave-vector k₄ is diffracted or reflected in the one of the at least two further areas comprising the first of the at least two further types of diffractive elements without providing the another further output optical beam out of the first or the second further surface.

Further according to the fourth aspect of the invention, each of at least two types of diffractive elements may be for identifying a graphical layout, such that the at least two types of diffractive elements identify at least two different graphical layouts, and wherein each of the at least two further types of diffractive elements may be for identifying a graphical layout, such that the at least two further types of diffractive elements identify at least two further different graphical layouts, respectively. Further, all wave-vectors k₁, k₂, k₃ and k₄ may have at lease one of: a) substantially the same wavelength, b) k₁ and k₃ having substantially the same direction, and c) k₂ and k₄ having substantially the same direction. Further still, the wave-vectors k₁ and k₂ may have substantially one wavelength, and the wave-vectors k₃ and k₄ may have substantially further wavelength, wherein the further wavelength is different from the one wavelength. Still further, the substrate and the at least one further substrate may be placed one below another in parallel planes such that at least one graphical layout out of the two different graphical layouts may be adapted to be displayed in a region seen by a user of the optical device and at least one further graphical layout out of the at least two further different graphical layouts is adapted to be displayed in the region seen by the user as well.

According further to the fourth aspect of the invention, the at least two further different graphical layouts may be two different areas of the further substrate, the at least two further different graphical layouts are not overlapping each other.

According still further to the fourth aspect of the invention, the at least two further different graphical layouts may be provided in the same area of the further substrate and overlap each other.

According to a fifth aspect of the invention, an optical device, comprises:
means for disposing, made of optical material comprising a first surface and a second surface, wherein there are at least two areas on the means for disposing each comprising one of at least two types of diffractive elements disposed on the first or the second surface of the means for disposing, wherein periodic lines of a first of the at least two types of diffractive elements have a direction of the periodic lines substantially different from a direction of further periodic lines of a second of the at least two types of diffractive elements according to a predetermined criterion; and

means for providing at least two types of optical beams defined by wave-vectors k₁ and k₂, respectively, wherein both optical beams are substantially confined between the first and the second surfaces due to a total internal reflection, wherein
at least part of the optical beam defined by the wave-vector k₁ is diffracted in one of the at least two areas comprising the first of the at least two types of diffractive elements providing an output optical beam out of the first or the second surface, wherein the optical beam defined by the wave-vector k₁ is diffracted or reflected in another of at least two areas comprising the second of the at least two types of diffractive elements without providing the output optical beam out of the first or the second surface, and
at least part of the optical beam defined by the wave-vector k₂ is diffracted in the another of at least two areas comprising the second of the at least two types of diffractive elements providing a further output optical beam out of the first or the second surface, wherein the optical beam defined by the wave-vector k₂ is diffracted or reflected in the one of the at least two areas comprising the first of the at least two types of diffractive elements without providing the further output optical beam out of the first or the second surface.

According further to the fifth aspect of the invention, the means for disposing may be a substrate and the means for providing at least two types of optical beams are optical sources.

### BRIEF DESCRIPTION OF THE DRAWINGS

FIGS. 1a and 1b are schematic representations (top and edge views, respectively) showing a principle of a pixel illumination for providing different graphical layouts, according to an embodiment of the present invention;

FIG. 2 is a schematic representation showing input angle of an optical beam relative to a direction of the grating lines;

FIG. 3 is a block diagram of an electronic device for providing illumination for different graphics layouts, e.g., for a keyboard and LCD backlight, according to an embodiment of the present invention;

FIG. 4 is a representation of pixels showing letters “1” and “A” without illumination;

FIGS. 5a and 5b are representations of pixels demonstrating two types of illumination showing letters “1” and “A” when different types of illumination are provided, according to an embodiment of the present invention.

FIG. 6 is a top view of four different types of graphical layouts which can be displayed using one color or multiple colors based on the principle of a pixel illumination, according to an embodiment of the present invention;

FIGS. 7a-7c are cross sections demonstrating implementation of four different types of graphical layouts of FIG. 6 using two-substrate arrangement in different parallel planes with one or two colors, according to embodiments of the present invention;

FIG. 8 is a top view demonstrating implementation of four different types of graphical layouts of FIG. 6 using multiple-substrate arrangement, according to an embodiment of the present invention; and

FIGS. 9a-9b are a top view and a cross section demonstrating implementation of four different types of graphical layouts of FIG. 6 using one-substrate arrangement in one plane with two (or more) colors, according to an embodiment of the present invention.

### MODES FOR CARRYING OUT THE INVENTION

A new method, apparatus and software product are presented for illuminating different graphical layouts in a component comprising an optical device, e.g., in a keyboard or in a liquid crystal display (LCD) using an LCD panel backlight, of an electronic device. The electronic device can be, but not be limited to, a wireless communication device, a portable electronic device, a mobile phone, a display device, a keyboard electronic device, a camera-phone mobile device, etc.

According to embodiments of the present invention, the optical device uses a diffractive planar waveguide comprising diffraction gratings disposed on a lightguiding plate (substrate) and the property that a short period diffractive grating has no diffraction orders at certain conical angles, that couple the light out from the plate (the conical angle is an angle between the plane of an incident beam and a plane perpendicular to the periodic lines of a diffraction grating). Therefore the out-coupling gratings on the waveguide can be designed so that the optical beam coming from a certain direction can be effectively coupled out of the waveguide or be kept confined inside of the waveguide due to a total internal reflection. Then different graphics (or graphical layouts) can be disposed (e.g., printed) on the waveguide using pixels having diffraction gratings with the periodic lines at different orientations. Therefore, by arranging the diffraction gratings in a predetermined pixel format, any graphics can be shown (illuminated).

Thus, according to an embodiment of the present invention, a method for illuminating a component (e.g., a key of the keyboard or an LCD panel) of the electronic device, e.g., can comprise of: receiving an optical beam, defined by a wave-vectors k₁ or by a wave-vector k₂, by a substrate of optical material contained in the component and comprising a first surface and an opposing second surface, wherein at least two areas on the substrate each comprising one of at least two types of diffractive elements disposed on the first or the second surface of the substrate, and wherein periodic lines of a first of the at least two types of diffractive elements have a direction of the periodic lines substantially different from a direction of further periodic lines of a second of the at least two types of diffractive elements, according to a predetermined criterion. Further, the optical beam propagates substantially between the first and the second surfaces due to a total internal reflection. Still further, the optical beam defined by the wave-vector k₁ is at least partly diffracted in pixels with the first of the at least two types of diffractive elements providing an output optical beam out of the first or the second surface of the substrate, wherein the optical beam defined by the wave-vector k₁ is diffracted or reflected in pixels with the second of the at least two types of diffractive elements without providing the output optical beam out of the first or the second surface of the substrate. Yet still further, the optical beam defined by the wave-vectors k₂ is at least partly diffracted in pixels with the second of the at least two types of diffractive elements providing a further output optical beam out of the first or the second surface, wherein the optical beam defined by the wave-vector k₂ is diffracted or reflected in pixels with the first of the at least two types of diffractive elements without providing the further output optical beam out of the first or the second surface of the substrate.

The above example considers the at least two areas on the substrate with corresponding at least two types of diffractive elements identifying at least two types of graphical layouts and corresponding optical beams defined by the wave-vectors k₁ and k₂. According to an embodiment of the present invention, it can be more than two areas on the substrate with corresponding types of diffractive elements identifying more than two corresponding layouts and which will use corresponding optical beams defined by corresponding wave-vectors, each identifying only one graphical layout as described above.

According to an embodiment of the present invention, any of the at least two areas can comprise a group of pixels with identical diffractive properties, wherein said pixels have identical or non-identical shapes and sizes.

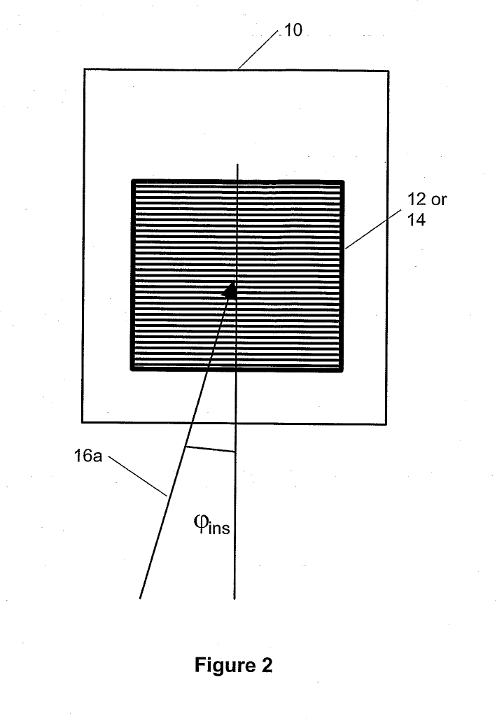

According to embodiments of the present invention, the direction of the periodic lines of the first of the at least two types of diffractive elements can be perpendicular (among other possibilities) to the direction of said further periodic lines of a first of the at least two types of diffractive elements, according to the predetermined criterion. Then, the optical beam defined by the wave-vector k₁ can be in a plane substantially perpendicular to the periodic lines and the optical beam defined by the wave-vector k₂ can be in a plane substantially perpendicular to the further periodic lines as discussed below in detail regarding FIG. 2. Further, periods of the periodic lines and further periodic lines can be different or can be the same and chosen using said predetermined criterion.

Moreover, according to embodiments of the present invention, the optical beams with the wave-vectors k₁ and k₂ can have the same or different angles of incidence on said substrate, the optical beams with said wave-vectors k₁ and k₂ can have substantially the same wavelength (the same color) or different wavelengths, and the optical beams with said wave-vectors k₁ and k₂ can be provided by light emitting diodes (LEDs) among other light sources. Simple LED coupling using one or two LEDs can be used and provided by an appropriate optical and mechanical design.

Furthermore, according to embodiments of the present invention, both of the at least two types of diffractive elements can be disposed on one surface, the first or the second surface, of the substrate or each of the at least two types of diffractive elements can be disposed on different surfaces, the first and the second surfaces of the substrate. The former does require that two (or more) graphical layouts should be side-by-side and not overlapping, whereas the latter does not require that two graphical layouts should be side-by-side and allow them to be overlapping.

Also, it is noted that various embodiments of the present invention recited herein can be used separately, combined or selectively combined for specific applications.

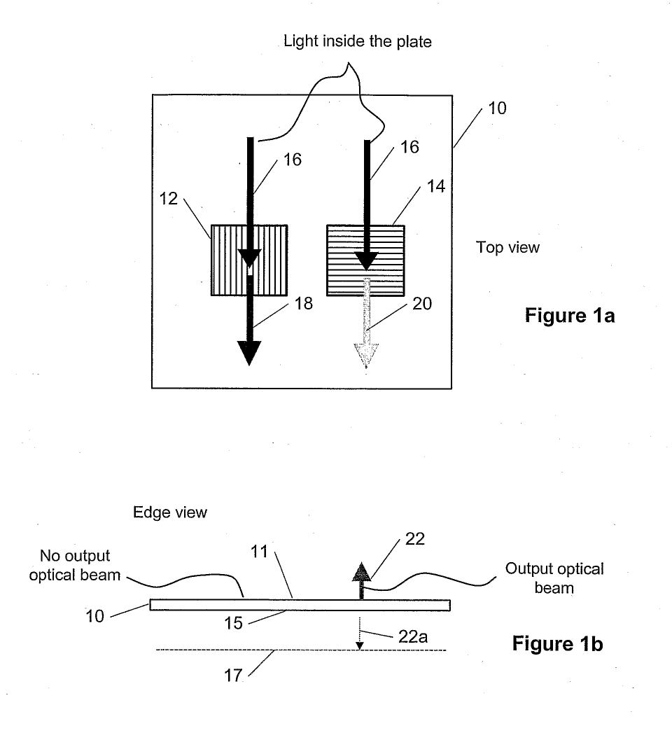

FIGS. 1a and 1b are examples among others of schematic representations (top and edge views, respectively) showing a principle of a pixel illumination for providing different graphical layouts, according to an embodiment of the present invention. The optical beam 16, which is e.g., in a plane perpendicular to periodic lines of a diffractive element (or a diffraction grating) identifying a pixel 14 and parallel to periodic lines of a further diffractive element (or a further diffraction grating) identifying a pixel 12, propagates through the substrate 10 by a total internal reflection (TIR). The beam 16 for the shown direction is diffracted reflectively in the pixel 14 disposed on the substrate 10 generating an optical beam 20 (e.g., a first order reflecting mode) which continues to propagate through the substrate 10 by the TIR. The beam 16 is also diffracted transmissively in the pixel 14 generating an output optical beam 22 from a first surface 11 of the substrate 10. If the beam 20 has an incidence angle on the second surface 15 of the substrate 10 below a critical angle for the TIR, a further output optical beam 22a is coupled out of the second surface 15. The beam 22a can be further coupled in a desired direction of the beam 22 using an additional mirror 17.

The beam 16 is not diffracted transmissively in the pixel 12 disposed on the substrate 10 and thus does not generate the output optical beam. Even if reflective diffraction mode (a beam 18) exists in the pixel 12, it is confined to the substrate 10 due to the TIR (this subject is further discussed in regard to FIG. 2). Thus, for the shown direction of the beam 16, the pixel 14 (and therefore the graphical layout associated with the pixel 14) is lighted up, and the pixel 12 (and therefore the graphical layout associated with the pixel 12) is in the dark. If the direction of the beam 16 is rotated by 90°, the situation will be reversed: i.e., the pixel 12 will be lighted up and the pixel 14 will be in the dark.

FIG. 2 is a schematic representation showing an input angle of an optical beam 16a (defined by the wave-vector k₁ or k₂) relative to a direction of the grating lines of the diffractive element 12 or 14 (elements are shown out of scale). Let us assume that the beam 16a bounces due to the TIR from the surfaces of the substrate 10 at the angle θᵢₙₛ inside the plate and forms and angle of θᵢₙₛ with respect to the periodic lines of the diffractive element 12 or 14.

The condition that the light is not diffracted to the first transmissive order is:

$$\vert {n}^{2} {sin}^{2} {θ}_{ins} + \frac{{λ}^{2}}{{d}^{2}} + 2 \frac{λ}{d} n sin {θ}_{ins} cos {ϕ}_{ins} \vert > 1 , \qquad ( 1 )$$

wherein d is a period of the diffraction grating 12 or 14, n is an index of refraction of the substrate 10, and λ is a wavelength of the optical beam 16a.

If the transmissive out-coupling is perpendicular to the plate when λᵢₙₛ=0, then the grating period is preferable to satisfy the equation

$$\frac{λ}{d} = n sin {θ}_{ins}$$

which implies that

|1−cos φᵢₙₛ|>d²/2λ² (2).

From Equation 2 it follows that the smaller d the larger the angle φᵢₙₛ can be. In a practical case the angle θᵢₙₛ can be 45°, therefore

$$\frac{λ}{d} = n / \sqrt{2}$$

and the condition that the light is not diffracted to the first transmissive order is

|1−cos φᵢₙₛ|>1/n² (3)

If n=1.5, there will be no out-coupling if |φᵢₙₛ|>56.3°. Therefore, if the diffraction elements 12 and 14 have periodic lines perpendicular to each other, e.g., φᵢₙₛ=0 for the element 12 and φᵢₙₛ=90° for the element 14, the optical beam will be transmissively diffracted in the element 14 but not in the element 12.

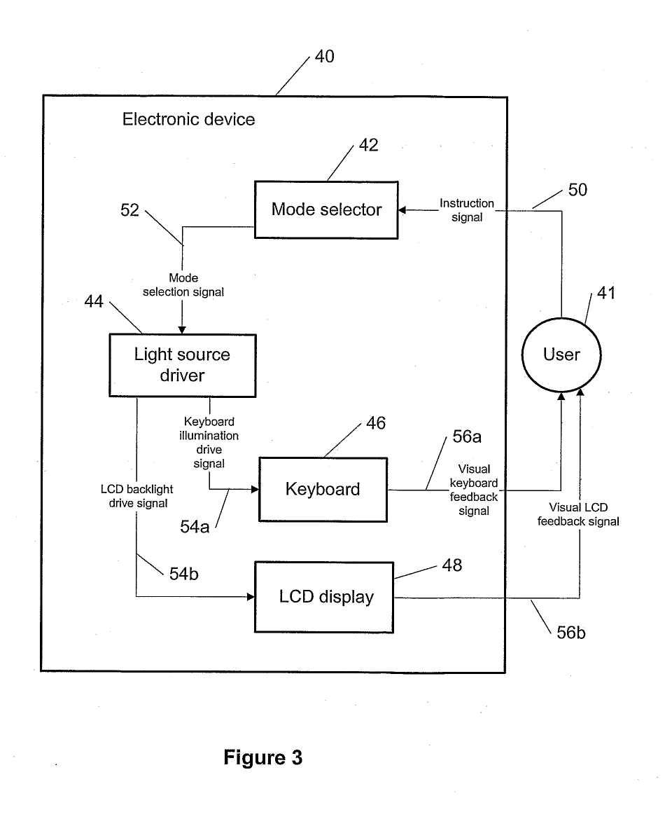

FIG. 3 is an example among others of a block diagram of an electronic device 40 for providing illumination for different graphical layouts, e.g., for a keyboard and LCD backlight, according to an embodiment of the present invention.

A user 41 provides an instruction signal 50 about the graphical layout to be illuminated to a mode selector 42. In response, the mode selector 42 provides a mode selection signal 52 to a light source driver 44. In response, the light source driver 44 provides a keyboard illumination drive signal 54a to light sources (e.g., LEDs) incorporated in individual keys of a keyboard 46 for illuminating the desired graphical layout using the diffractive planar waveguide method described in the embodiments of the present invention. Similarly, the light source driver 44 provides an LCD illumination drive signal 54b to light sources (e.g., LEDs) incorporated in the LCD panel backlight system for illuminating the desired graphical layout on the LCD panel using the diffractive planar waveguide method described in the embodiments of the present invention. Also signals 56a and 56b are shown in FIG. 3 as feedback signals to the user 41 for verifying that the desired graphical layout is illuminated.

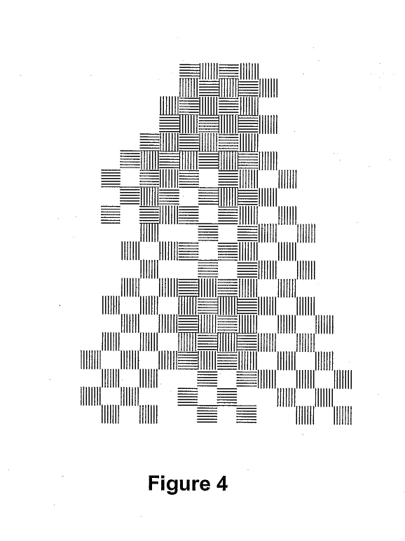

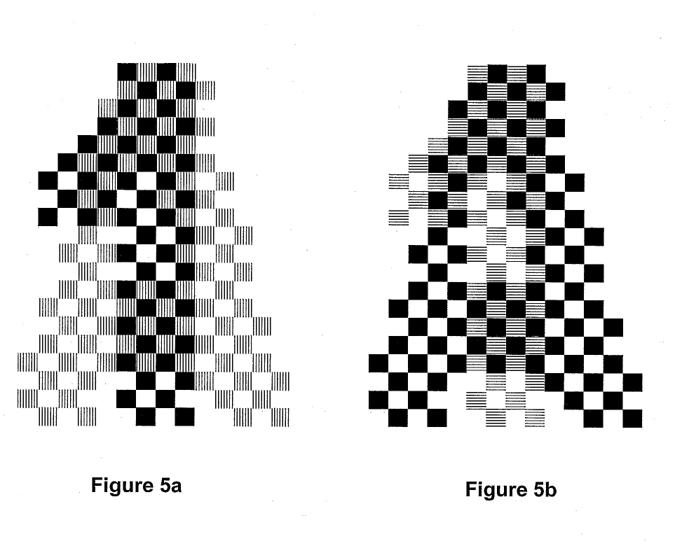

FIGS. 4 and 5 demonstrate an example among others of possible graphical layouts to be displayed according to embodiments of the present invention. FIG. 4 is a representation of pixels showing letters “1” and “A” without illumination, and FIGS. 5a and 5b are representations of pixels demonstrating two types of illumination showing letters “1” and “A” when different types of illumination are provided. Further implementation examples are presented below.

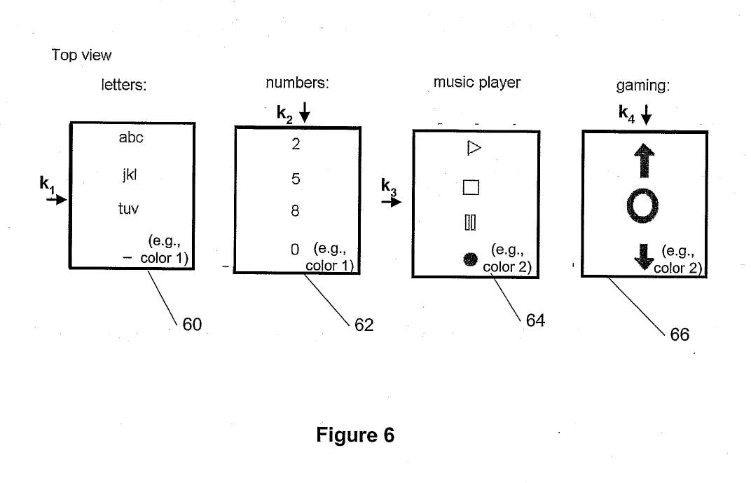

FIG. 6 shows an example among others of a top view of four different types of graphical layouts 60, 62, 64 and 66 which can be displayed with one color or multiple colors using the principle of the pixel illumination. The graphical layouts 60 and 62 can be implemented using the embodiments of the present invention, e.g., using the overlapping approach (i.e., the layouts are provided in the same area of the substrate) as shown in FIGS. 5a and 5b, with vectors k₁ and k₂ for illumination of the graphical layouts 60 and 62, respectively. Also these layouts 60 and 62 can occupy two different areas of the substrate, wherein the two layouts 60 and 62 are not overlapping each other.

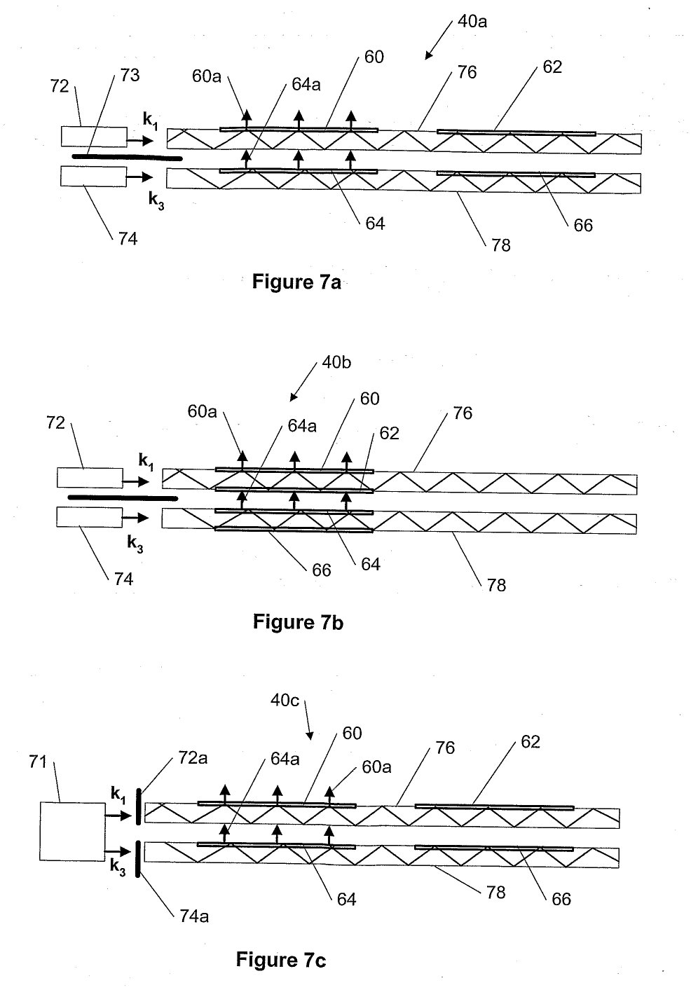

The graphical layouts 64 and 66 can be implemented in a variety of ways using the same principle as applied to the layouts 60 and 62 as described above according the embodiments of the present invention. For example, the layouts 64 and 66 can be implemented on a different optical substrate (as discussed below) e.g., using the overlapping approach (i.e., the layouts are provided in the same area of the substrate) with vectors k₃ and k₄ for illumination of the graphical layouts 64 and 66, respectively. Also these layouts 64 and 66 can occupy two different areas of the different optical substrate, wherein the two layouts 64 and 66 are not overlapping each other. In general, all wave-vectors k₁, k₂, k₃ and k₄ may have substantially the same wavelength (color) and/or the same direction depending on a particular design (e.g., see FIGS. 7a-7c, 8 and 9a-9c). On the other hand, the wave-vectors k₁ and k₂ may have substantially one wavelength (e.g., having red color), and the wave-vectors k₃ and k₄ may have substantially different wavelengths (e.g., having blue color).

FIGS. 7a-7c show examples among others of cross sections demonstrating implementation of four different types of graphical layouts shown in FIG. 6 using two-substrate arrangement using substrates 76 and 78 in different parallel planes with one or two colors, according to embodiments of the present invention. These graphical layouts can be parts of corresponding electronic devices 40a, 40b and 40c in FIGS. 7a, 7b and 7c, respectively. The shown configurations will allow to use more effectively, e.g., the display areas of the electronic device, wherein the same region seen by the user on the screen can display alternatively or simultaneously multiple graphical layouts, thus minimizing the size of the electronic device. FIGS. 7a-7c show two-substrate arrangement but the same principle can be applied to a larger number of substrates.

In FIG. 7a, the graphical layouts 60 and 62 are implemented on the substrate 76 and the graphical layouts 64 and 66 are implemented on the substrate 78 using the non-overlapping approach. The optical sources (e.g., LEDs of the same or different colors) 72 and 74 provide optical beams with the wave-vectors k₁ and k₃, respectively, wherein the beam with the wave-vector k₁ generates the output optical beam 60a and the beam with the wave-vector k₃ generates the output optical beam 64a, respectively. The optical beams 60a and 64a can be generated one at a time or simultaneously using non-overlapping or appropriate overlapping approach by switching the optical sources 72 and 74. An isolation screen 73 may be used for providing optical isolation between the two substrates 76 and 78.

FIG. 7b demonstrates a similar approach as shown in FIG. 7a but with the graphical layouts 62 and 66 disposed on the opposite sided on the corresponding optical substrates 76 and 78. In FIG. 7b, the same region seen by the user, e.g., on, the screen of the electronic device can display four graphical layouts 60, 62, 64 and 66 one at a time or a combination thereof.

FIG. 7c demonstrates yet another variation of the approach shown in FIG. 7a. In FIG. 7c, the optical source 71 (e.g. a two-color LED) can provide two optical beams of different colors (simultaneously or one at a time), wherein the beam with the appropriate color for each substrate is selected using a band-bass filters 72a and 74a, respectively.

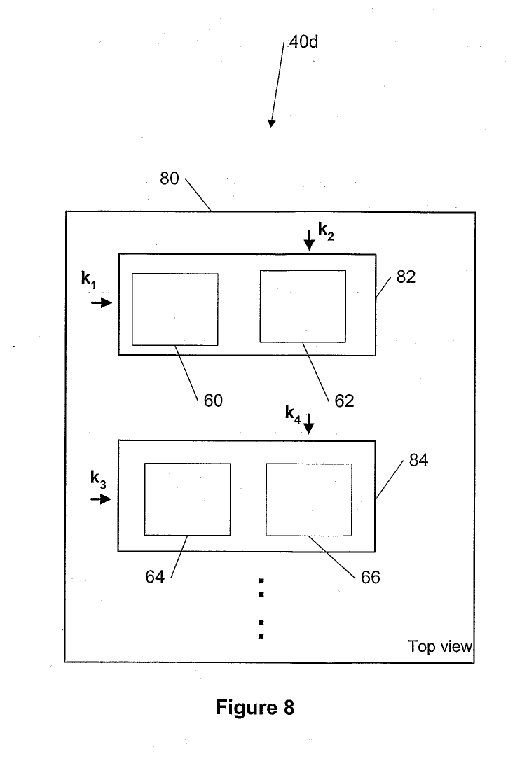

FIG. 8 shows another example among many others of a top view demonstrating implementation of four different types of graphical layouts of FIG. 6 using planar multiple-substrate arrangement, wherein the substrates 82 and 84 are attached, e.g., to a display 80 of an electronic device 40d, according to an embodiment of the present invention. Each of the substrates 82 and 84 can operate independently having its own optical illuminating sources using the same or different colors. In addition each of the substrates 82 and 84 can have one or more substrates placed below to facilitate the multiple-substrate (e.g., two-substrate) arrangement shown in FIGS. 7a-7c.

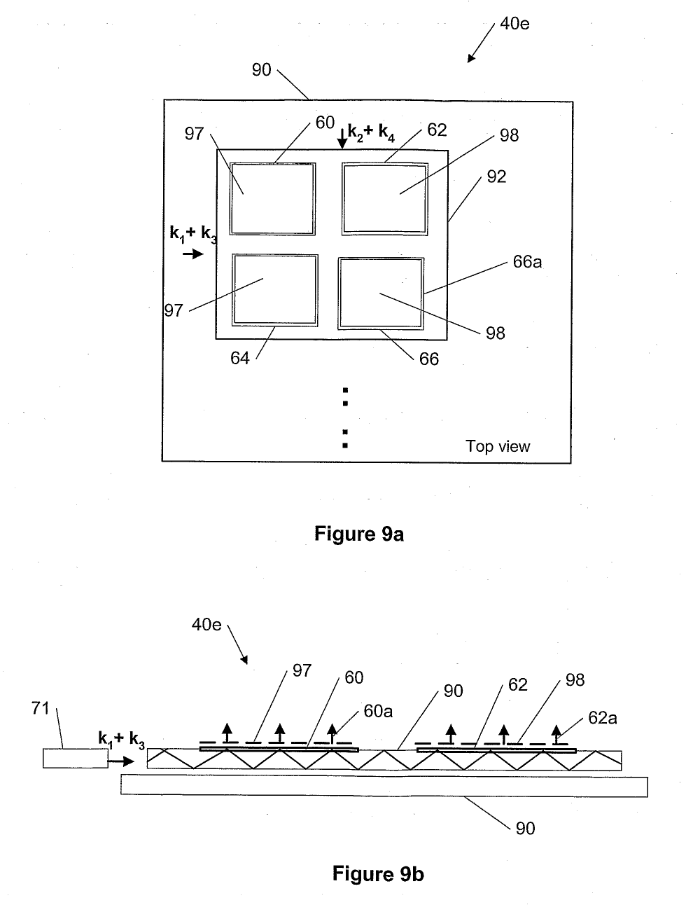

FIGS. 9a-9b show yet another example among others of a top view (FIG. 9a) and a cross section (FIG. 9b) demonstrating implementation of four different types of graphical layouts of FIG. 6 using one-substrate arrangement in one plane with two colors (or more than 2 colors), wherein the substrate 92 is attached, e.g., to a display 90 of an electronic device 40e, according to an embodiment of the present invention. Two colors (e.g., one color for the wave-vectors k₁ and k₃ and another color for the wave-vectors k₂ and k₄ as shown in FIG. 9a) may be used. FIGS. 9a and 9b also show that each of the of graphical layouts 60, 62, 64 and 66 can be covered by an optical band-pass filter (e.g., an absorbing layer or an interference filter) transparent to at least one optical beam which identifies the particular layout but opaque to another optical beam having a different wavelength. In particular, the layouts 60 and 64 utilizing the optical beams with the wave-vectors k₁ and k₃ of the one wavelength for their identification are covered with a band-pass filter 97, which passes the output optical beam (e.g., the beam 60a in FIG. 9b) with this one wavelength but rejects the output optical beam with another wavelength used for identifying the layouts 62 and 66. Similarly, the layouts 62 and 66 utilizing the optical beams with the wave-vectors k₂ and k₄ for their identification are covered with a band-pass filter 98 which passes the output optical beam (e.g., the beam 62a in FIG. 9b) with this another wavelength but reject the output optical beam with the one wavelength used for identifying the layouts 62 and 66. In addition, the embodiment shown in FIGS. 9a and 9b can further utilize a multi-substrate approach as shown in FIGS. 7a-7c and/or 8.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. An optical device, comprising:
a substrate of optical material comprising a first surface and a second surface; and
at least two types of diffractive elements each disposed on one of at least two areas on said substrate on the first or the second surface, wherein periodic lines of a first of said at least two types of diffractive elements have a direction substantially different from a direction of further periodic lines of a second of said at least two types of diffractive elements according to a predetermined criterion,
wherein
at least part of an optical beam defined by a wave-vector k₁ and confined between said first and said second surfaces is diffracted in one of said at least two areas comprising said first of said at least two types of diffractive elements providing an output optical beam out of the first or the second surface, wherein said optical beam defined by said wave-vector k₁ is diffracted or reflected in another of at least two areas comprising said second of said at least two types of diffractive elements without providing said output optical beam out of the first or the second surface, and
at least part of another optical beam defined by a wave-vector k₂ and confined between said first and said second surfaces is diffracted in said another of at least two areas comprising said second of said at least two types of diffractive elements providing a further output optical beam out of the first or the second surface, wherein said another optical beam defined by said wave-vector k₂ is diffracted or reflected in said one of said at least two areas comprising said first of said at least two types of diffractive elements without providing said further output optical beam out of the first or the second surface.

2. The optical device of claim 1, wherein the direction of said periodic lines is perpendicular to the direction of said further periodic lines.

3. The optical device of claim 1, wherein said optical beam defined by said wave-vector k₁ is in a plane substantially perpendicular to said periodic lines and said optical beam defined by said wave-vector k₂ is in a plane substantially perpendicular to said further periodic lines.

4. The optical device of claim 1, wherein said optical beams with said wave-vectors k₁ and k₂ have different angles of incidence on said substrate.

5. The optical device of claim 1, wherein said optical beams with said wave-vectors k₁ and k₂ have substantially the same wavelength.

6. The optical device of claim 1, wherein said optical beams with said wave-vectors k₁ and k₂ are provided by light emitting diodes.

7. The optical device of claim 1, wherein each of said at least two types of diffractive elements is for identifying a graphical layout, such that said at least two types of diffractive elements identify at least two different graphical layouts, respectively.

8. The optical device of claim 7, wherein said at least two different graphical layouts are two different areas of the substrate, said at least two different graphical layouts are not overlapping each other.

9. The optical device of claim 7, wherein said at least two different graphical layouts are provided in the same area of the substrate and overlap each other.

10. The optical device of claim 7, wherein N different graphical layouts of said at least two different graphical layouts are provided on said substrate, wherein said N different graphical layouts are identified using 2N optical beams with corresponding 2N wave-vectors k₁, k₂, . . . k_{2N} provided to said substrate.

11. The optical device of claim 10, wherein at least one optical beam has a wavelength different from other wavelengths of said 2N optical beams and wherein a graphical layout identified by said at least one optical beam is covered by an optical band-pass filter transparent to said at least one optical beam but opaque to any optical beam out of said N optical beams which has a wavelength different from the wavelength of said at least one optical beam.

12. The optical device of claim 1, wherein both of said at least two types of diffractive elements are disposed on one surface, the first or the second surface of said substrate.

13. The optical device of claim 1, wherein each of said at least two types of diffractive elements are disposed on different surfaces, the first and the second surfaces of said substrate.

14. The optical device of claim 1, wherein any of said at least two areas comprise a group of pixels with identical diffractive properties, wherein said pixels have identical or non-identical shapes and sizes.

15. The optical device of claim 1, further comprising:
at least one further substrate of optical material comprising a first further surface and a second further surface; and
at least two types of further diffractive elements each disposed on one of at least two further areas on said at least one further substrate on the first or the second further surface, wherein periodic lines of a first of said at least two types of further diffractive elements have a direction substantially different from a direction of further periodic lines of a second of said at least two further types of diffractive elements according to a predetermined criterion,
wherein
at least part of an optical beam defined by a wave-vector k₃ and confined between said first and said second further surfaces is diffracted in one of said at least two further areas comprising said first of said at least two further types of diffractive elements providing another output optical beam out of the first or the second further surface, wherein said optical beam defined by said wave-vector k₃ is diffracted or reflected in another of at least two further areas comprising said second of said at least two further types of diffractive elements without providing said another output optical beam out of the first or the second surface, and
at least part of another optical beam defined by said wave-vector k₄ and confined between said first and said second further surfaces is diffracted in said another of at least two further areas comprising said second of said at least two further types of diffractive elements providing another further output optical beam out of the first or the second further surface, wherein said another optical beam defined by said wave-vector k₄ is diffracted or reflected in said one of said at least two further areas comprising said first of said at least two further types of diffractive elements without providing said another further output optical beam out of the first or the second further surface.

16. The optical device of claim 15, wherein each of at least two types of diffractive elements is for identifying a graphical layout, such that said at least two types of diffractive elements identify at least two different graphical layouts, and wherein each of the at least two further types of diffractive elements is for identifying a graphical layout, such that said at least two further types of diffractive elements identify at least two further different graphical layouts, respectively.

17. The optical device of claim 16, wherein all wave-vectors k₁, k₂, k₃ and k₄ have at lease one of: a) substantially the same wavelength, b) k₁ and k₃ having substantially the same direction, and c) k₂ and k₄ having substantially the same direction.

18. The optical device of claim 16, wherein the wave-vectors k₁ and k₂ have substantially one wavelength, and the wave-vectors k₃ and k₄ have substantially further wavelength, wherein the further wavelength is different from the one wavelength.

19. The optical device of claim 16, wherein said substrate and said at least one further substrate are placed one below another in parallel planes such that at least one graphical layout out of said two different graphical layouts is adapted to be displayed in a region seen by a user of said optical device and at least one further graphical layout out of said at least two further different graphical layouts is adapted to be displayed in said region seen by the user as well.

20. The optical device of claim 15, wherein said at least two further different graphical layouts are two different areas of the further substrate, said at least two further different graphical layouts are not overlapping each other.

21. The optical device of claim 15, wherein said at least two further different graphical layouts are provided in the same area of the further substrate and overlap each other.

22. A method, comprising:
receiving an optical beam, defined by a wave-vector k₁ or by a wave-vector k₂, by a substrate of optical material comprising a first surface and a second surface, wherein at least two areas on said substrate each comprising one of at least two types of diffractive elements disposed on the first or the second surface of the substrate, wherein periodic lines of a first of said at least two types of diffractive elements have a direction of said periodic lines substantially different from a direction of further periodic lines of a second of said at least two types of diffractive elements;
propagating said optical beam substantially between said first and said second surfaces due to a total internal reflection;
diffracting, if said optical beam is defined by said wave-vector k₁, at least part of said optical beam defined by said wave-vector k₁ in one of said at least two areas comprising said first of said at least two types of diffractive elements providing an output optical beam out of the first or the second surface, wherein said optical beam defined by said wave-vector k₁ is diffracted or reflected in another of said at least two areas comprising the second of said at least two types of diffractive elements without providing said output optical beam out of the first or the second surface or
diffracting, if said optical beam is defined by said wave-vectors k₂, at least part of said optical beam defined by said wave-vector k₂ in said another of said at least two areas comprising said second of said at least two types of diffractive elements providing a further output optical beam out of the first or the second surface, wherein said optical beam defined by said wave-vector k₂ is diffracted or reflected in said one of said at least two areas comprising said first of said at least two types of diffractive elements without providing said further output optical beam out of the first or the second surface.

23. The method of claim 22, wherein the direction of said periodic lines is perpendicular to the direction of said further periodic lines.

24. The method of claim 22, wherein said optical beam defined by said wave-vector k₁ is in a plane substantially perpendicular to said periodic lines and said optical beam defined by said wave-vector k₂ is in a plane substantially perpendicular to said further periodic lines.

25. The method of claim 22, wherein said optical beams with said wave-vectors k₁ and k₂ have different angles of incidence on said substrate.

26. The method of claim 22, wherein said optical beams with said wave-vectors k₁ and k₂ have substantially the same wavelength.

27. The method of claim 22, wherein said optical beams with said wave-vectors k₁ and k₂ are provided by light emitting diodes.

28. The method of claim 22, wherein each of said at least two types of diffractive elements is for identifying a graphical layout, such that said at least two types of diffractive elements identify at least two different graphical layouts, respectively.

29. The method of claim 28, wherein said at least two different graphical layouts are two different areas of the substrate, said at least two different graphical layouts are not overlapping each other.

30. The method of claim 28, wherein said at least two different graphical layouts are provided in the same area of the substrate and overlap each other.

31. The method of claim 28, wherein N different graphical layouts of said at least two different graphical layouts are provided on said substrate, wherein said N different graphical layouts are identified using 2N optical beams with corresponding 2N wave-vectors k₁, k₂, . . . k_{2N} provided to said substrate.

32. The method of claim 31, wherein at least one optical beam has a wavelength different from other wavelengths of said 2N optical beams and wherein a graphical layout identified by said at least one optical beam is covered by an optical band-pass filter transparent to said at least one optical beam but opaque to any optical beam out of said N optical beams which has a wavelength different from the wavelength of said at least one optical beam.

33. The method of claim 22, wherein both of said at least two types of diffractive elements are disposed on one surface, the first or the second surface of said substrate.

34. The method of claim 22, wherein each of said at least two types of diffractive elements are disposed on different surfaces, the first and the second surfaces of said substrate.

35. The method of claim 22, wherein said substrate is a part of a component which is a key of a keyboard or a liquid crystal display.

36. (canceled)

37. The method of claim 22, wherein any of said at least two areas comprise a group of pixels with identical diffractive properties, wherein said pixels have identical or non-identical shapes and sizes.

38. The method of claim 22, further comprising:
receiving an optical beam, defined by a wave-vector k₃ or by a wave-vector k₄, by a further substrate of optical material comprising a first further surface and a second further surface, wherein at least two further areas on said further substrate each comprising one of at least two further types of diffractive elements disposed on the first or the second further surface of the further substrate, wherein periodic lines of a first of said at least two further types of diffractive elements have a direction of said periodic lines substantially different from a direction of further periodic lines of a second of said at least two further types of diffractive elements;
propagating said optical beam substantially between said first and said second further surfaces due to a total internal reflection;
diffracting, if said optical beam is defined by said wave-vector k₃, at least part of said optical beam defined by said wave-vector k₃ in one of said at least two further areas comprising said first of said at least two further types of diffractive elements providing another output optical beam out of the first or the second (further surface, wherein said optical beam defined by said wave-vector k₃ is diffracted or reflected in another of said at least two further areas comprising the second of said at least two further types of diffractive elements without providing said another output optical beam out of the first or the second further surface or
diffracting, if said optical beam is defined by said wave-vectors k₄, at least part of said optical beam defined by said wave-vector k₄ in said another of said at least two further areas comprising said second of said at least two further types of diffractive elements providing another further output optical beam out of the first or the second further surface, wherein said optical beam defined by said wave-vector k₄ is diffracted or reflected in said one of said at least two further areas comprising said first of said at least two further types of diffractive elements without providing said another further output optical beam out of the first or the second further surface.

39. The method of claim 38, wherein each of at least two types of diffractive elements is for identifying a graphical layout, such that said at least two types of diffractive elements identify at least two different graphical layouts, and wherein each of the at least two further types of diffractive elements is for identifying a graphical layout, such that said at least two further types of diffractive elements identify at least two further different graphical layouts, respectively.

40. The method of claim 39, wherein all wave-vectors k₁, k₂, k₃ and k₄ have at lease one of: a) substantially the same wavelength, b) k₁ and k₃ having substantially the same direction, and c) k₂ and k₄ having substantially the same direction.

41. The method of claim 39, wherein the wave-vectors k₁ and k₂ have substantially one wavelength, and the wave-vectors k₃ and k₄ have substantially further wavelength, wherein the further wavelength is different from the one wavelength.

42. The method of claim 39, wherein said substrate and said at least one further substrate are placed one below another in parallel planes such that at least one graphical layout out of said two different graphical layouts is adapted to be displayed in a region seen by a user of said optical device and at least one further graphical layout out of said at least two further different graphical layouts is adapted to be displayed in said region seen by the user as well.

43. The method of claim 38, wherein said at least two further different graphical layouts are two different areas of the further substrate, said at least two further different graphical layouts are not overlapping each other.

44. The method of claim 38, wherein said at least two further different graphical layouts are provided in the same area of the further substrate and overlap each other.

45. A computer program product comprising: a computer readable storage structure embodying computer program code thereon for execution by a computer processor with said computer program code wherein said computer program code comprises instructions for performing the method of claim 22.

46. An electronic device, comprising:
an optical device, comprising
a substrate of optical material comprising a first surface and a second surface; and
at least two types of diffractive elements each disposed on one of at least two areas on said substrate on the first or the second surface, wherein periodic lines of a first of said at least two types of diffractive elements have a direction substantially different from a direction of further periodic lines of a second of said at least two types of diffractive elements according to a predetermined criterion,
wherein
at least part of an optical beam defined by a wave-vector k₁ and confined between said first and said second surfaces is diffracted in one of said at least two areas comprising said first of said at least two types of diffractive elements providing an output optical beam out of the first or the second surface, wherein said optical beam defined by said wave-vector k₁ is diffracted or reflected in another of at least two areas comprising said second of said at least two types of diffractive elements without providing said output optical beam out of the first or the second surface, and
at least part of another optical beam defined by a wave-vector k₂ and confined between said first and said second surfaces is diffracted in said another of at least two areas comprising said second of said at least two types of diffractive elements providing a further output optical beam out of the first or the second surface, wherein said another optical beam defined by said wave-vector k₂ is diffracted or reflected in said one of said at least two areas comprising said first of said at least two types of diffractive elements without providing said further output optical beam out of the first or the second surface,
optical sources for providing at least two types of optical beams defined by wave-vectors k₁ and k₂; and
a component comprising said substrate and said optical sources.

47. The electronic device of claim 46, wherein said component is a key of a keyboard or a liquid crystal display.

48. (canceled)

49. The electronic device of claim 46, wherein said electronic device is for wireless communications.

50. The electronic device of claim 46, wherein any of said at least two areas comprise a group of pixels with identical diffractive properties, wherein said pixels have identical or non-identical shapes and sizes.

51. The electronic device of claim 46, wherein each of said at least two types of diffractive elements is for identifying a graphical layout, such that said at least two types of diffractive elements identify at least two different graphical layouts, respectively.

52. The electronic device of claim 51, wherein said at least two different graphical layouts are two different areas of the substrate, said at least two different graphical layouts are not overlapping each other.

53. The electronic device of claim 51, wherein said at least two different graphical layouts are provided in the same area of the substrate and overlap each other.

54. The electronic device of claim 51, wherein N different graphical layouts of said at least two different graphical layouts are provided on said substrate, wherein said N different graphical layouts are identified using 2N optical beams with corresponding 2N wave-vectors k₁, k₂, . . . k_{2N}.

55. The electronic device of claim 54, wherein at least one optical beam has a wavelength different from other wavelengths of said 2N optical beams and wherein a graphical layout identified by said at least one optical beam is covered by an optical band-pass filter transparent to said at least one optical beam but opaque to any optical beam out of said N optical beams which has a wavelength different from the wavelength of said at least one optical beam.

56. The electronic device of claim 46, wherein said optical device further comprises:
at least one further substrate of optical material comprising a first further surface and a second further surface; and
at least two types of further diffractive elements each disposed on one of at least two further areas on said at least one further substrate on the first or the second further surface of the at least one further substrate, wherein periodic lines of a first of said at least two types of further diffractive elements have a direction substantially different from a direction of further periodic lines of a second of said at least two further types of diffractive elements according to a predetermined criterion,
wherein
at least part of an optical beam defined by a wave-vector k₃ and confined between said first and said second further surfaces is diffracted in one of said at least two further areas comprising said first of said at least two further types of diffractive elements providing another output optical beam out of the first or the second further surface, wherein said optical beam defined by said wave-vector k₃ is diffracted or reflected in another of at least two further areas comprising said second of said at least two further types of diffractive elements without providing said another output optical beam out of the first or the second surface, and
at least part of another optical beam defined by said wave-vector k₄ and confined between said first and said second further surfaces is diffracted in said another of at least two further areas comprising said second of said at least two further types of diffractive elements providing another further output optical beam out of the first or the second further surface, wherein said another optical beam defined by said wave-vector k₄ is diffracted or reflected in said one of said at least two further areas comprising said first of said at least two further types of diffractive elements without providing said another further output optical beam out of the first or the second further surface.

57. The electronic device of claim 56, wherein each of the at least two types of diffractive elements is for identifying a graphical layout, such that said at least two types of diffractive elements identify at least two different graphical layouts, and wherein each of the at least two further types of diffractive elements is for identifying a graphical layout, such that said at least two further types of diffractive elements identify at least two further different graphical layouts, respectively.

58. The electronic device of claim 57, wherein all wave-vectors k₁, k₂, k₃ and k₄ have at lease one of: a) substantially the same wavelength, b) k₁ and k₃ having substantially the same direction, and c) k₂ and k₄ having substantially the same direction.

59. The electronic device of claim 57, wherein the wave-vectors k₁ and k₂ have substantially one wavelength, and the wave-vectors k₃ and k₄ have substantially further wavelength, wherein the further wavelength is different from the one wavelength.

60. The electronic device of claim 57, wherein said substrate and said at least one further substrate are placed one below another in parallel planes such that at least one graphical layout out of said two different graphical layouts is adapted to be displayed in a region seen by a user of said optical device and at least one further graphical layout out of said at least two further different graphical layouts is adapted to be displayed in said region seen by the user as well.

61. The electronic device of claim 57, wherein said at least two further different graphical layouts are two different areas of the further substrate, said at least two further different graphical layouts are not overlapping each other.

62. The electronic device of claim 57, wherein said at least two further different graphical layouts are provided in the same area of the further substrate and overlap each other.

63. (canceled)

64. (canceled)

65. The electronic device of claim 46, further comprising:
a mode selector, responsive to an instruction signal, configured to provide a mode selection signal in response to said instruction signal, wherein said mode selection signal indicates whether said optical beam with said wave-vectors k₁ or k₂ is used; and
a light source driver, responsive to said mode selection signal, configured to provide a drive signal to said light sources in said component for providing said optical beam with said wave-vectors k₁ or k₂.
